(19) United States
(12) Patent Application Publication
(10) Pub. No.: US 2008/0075260 A1
(43) Pub. Date: Mar. 27, 2008

(54) Method and system for providing calling area information

(76) Inventors: Ali Bastani, Branchburg, NJ (US); David G. Belanger, Hillsborough, NJ (US); Sam Parker, Cranbury, NJ (US); Phyllis Weiss, Englewood, NJ (US)

Correspondence Address: AT&T CORP., ROOM 2A207, ONE AT&T WAY, BEDMINSTER, NJ, 07921, US

(21) Appl. No.: 11/513,462

(22) Filed: Aug. 31, 2006

(51) Int. Cl. H04M 7/00

(52) U.S. Cl. 379/219

(57) ABSTRACT

Disclosed is a method and server for providing a calling area map to a client device. The server receives a query from a client device. The query includes at least a portion of a calling telephone number and may additionally include at least a portion of a called telephone number. The server retrieves a calling area map associated with the at least a portion of the calling telephone number from a plurality of stored calling area maps. The server transmits the retrieved calling area map to the client device.

### BACKGROUND OF THE INVENTION

The present invention relates generally to telephone calls and more particularly to providing information about a calling area for a telephone number.

Before dialing a telephone number, a customer of a telephone service provider may call an operator of the telephone service provider to determine whether dialing the telephone number is a local or long distance telephone call. The determination by the operator may result in the customer deciding not to make the call (e.g., if the call is a long distance call) in order to save money.

To make this determination, the operator typically uses a computer to access information stored in a database. The computer may generate a response to the query of whether dialing a called party by a calling party is a local telephone call using a lookup table.

The determination of whether a call is a local call, however, is often time and labor intensive. In particular, a telephone service provider typically has to employ operators to answer customers' queries. To date, this information is only available in a tabular format and on an individual basis. Further, a computer, such as a server, typically has to perform a lot of processing after receiving a query to generate a local calling area map and determine whether a call is a local call for the customer.

Therefore, there remains a need to more efficiently and effectively determine information about a local calling area for a particular telephone number.

### BRIEF SUMMARY OF THE INVENTION

One embodiment of the present invention includes a method and server for providing a calling area map to a client device. The server receives a query from a client device. The query includes at least a portion of a calling telephone number and may additionally include at least a portion of a called telephone number. The server retrieves a calling area map associated with the at least a portion of the calling telephone number from a plurality of stored calling area maps. The server transmits the retrieved calling area map to the client device.

In one embodiment, the server generates the plurality of stored calling area maps. The generating step can include determining boundary lines for each of the plurality of stored calling area maps. The transmitting of the retrieved calling area map to the client device may further include transmitting a table associated with the calling area.

These and other advantages of the invention will be apparent to those of ordinary skill in the art by reference to the following detailed description and the accompanying drawings.

### BRIEF DESCRIPTION OF THE DRAWINGS

FIG. 1 is a block diagram of a client in communication with a server over a network in accordance with an embodiment of the present invention;

FIG. 2 is a block diagram of the components of a server in accordance with an embodiment of the present invention;

FIG. 3 is a flowchart showing the steps performed by the server in accordance with an embodiment of the present invention; and

FIG. 4 shows a high level block diagram of a computer system which may be used in an embodiment of the present invention.

### DETAILED DESCRIPTION

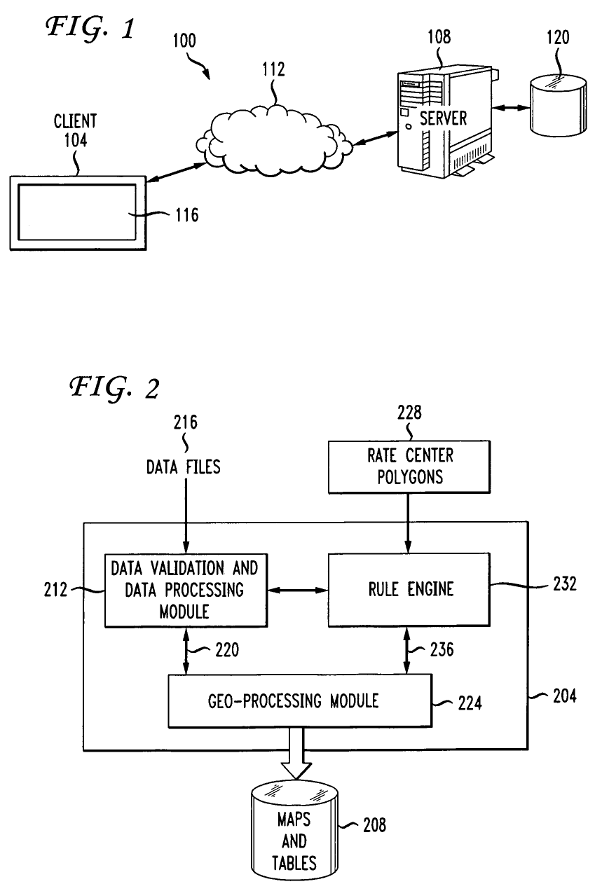

FIG. 1 is a block diagram of a system 100 having a client 104 communicating with a server 108 over a network 112. The client 104 transmits a query to the server 108 via the network 112 to request information (e.g., a local calling area map, table, or a statement, as described in more detail below) from the server 108 to provide a local calling area associated with a particular number (i.e., the calling number). The server 108 determines this information and transmits the result(s) back to the client 104. In one embodiment, the calling party displays the results on a web page shown on a web browser 116.

In one embodiment, before the server 108 receives a query from a client 104, the server 108 obtains information from a database 120. The information may be local calling area data for different telephone numbers. The first six digits of a telephone number are referred to as NPA-NXX (its prefix). The area code is the first three digits of the prefix (i.e., the NPA, or Number Plan Area). NXX refers to the exchange which is the three digits following the area code. Together, the six digits form a number unique to a specific Central Office (CO). In one embodiment, the information stored in the database 120 is updated periodically (e.g., once a week).

The server 108 can retrieve a specific amount of information from the database 120, such as in one or more files. For example, the server 108 can extract the following files from the database 120:

File 1

1. NPA.1

2. NXX.1

3. Group.1 (local calling group)

File 2

1. NPA.2

2. Group.2 (local calling group)

3. NPA.2 (local calling npa)

4. NXX.2 (local calling nxx)

5. Band (to help identify the type of local service)

File 3

1. NPA.3

2. NXX.3

3. RC.3 (Rate Center)

4. State.3

These files typically originate from a computer system and/or database. They provide the necessary information in a tabular format to help to identify a calling area. The telecommunication provider's operating areas may change. As a result, the files may be updated periodically (e.g., weekly).

A Local Calling Group is a list of telephone exchanges that are local for a given call originating exchange. A rate center is the geographic area used by local exchange carriers to set rate boundaries for billing and for issuing phone numbers.

From these files, the calling area (e.g., local calling area) of a call from a particular NPA.1 and NXX.1 in a state is determined by a list of all exchanges identified by NPA.2 and NXX.2, if:
NPA.1=NPA.2
   and Group.1=Group.2
   where State is defined by
State=State.3
   while NPA.1=NPA.3
NXX.1=NXX.3

In one embodiment, the server 108 uses the data retrieved from the database 120 to create local calling area maps (or tables). The server 108 identifies a list of Rate Centers from the records in File_{—}2, that are within the same local calling group (i.e., where NPA.1=NPA.2 and Group.1=Group.2). Thus, for every exchange which is local to an originating exchange, the local rate center, RC, and State are determined from
RC =RC.3

State=State.3

where
NPA.2=NPA.3
   and NXX.2=NXX.3
   A list of rate centers in a group may not be unique. The server 108 creates a local calling area map based on a union of distinct rate centers' polygons in the group. In a given state, multiple NPA Groups may correspond to only one local calling area map. The number of unique local calling area maps, M, in a state is determined from the number of possible distinct sets of all rate centers in the state. That is, if MAPₖ denotes the k^{th} map, then

MAPₖ={RC₁, RC₂, . . . , RCⱼ, . . . , RCₙ} for all k=1, 2, . . . , M

### For which,

RCⱼ=0 if rate center j is not present in the set

where j=1, 2, . . . , n and n is the number of rate centers in a state.

The server 108 uses the above method to create local calling area information (e.g., tables and/or maps) for all existing NPA-NXX's in every state. For example, for NPA-NXX's in the state of California, in one embodiment there are 680 distinct local calling area maps for a particular telephone service provider.

After creating the maps, the server 108 can store the maps (e.g., in its memory or in the database 120). The server 108 then indexes the NPA and Group values so that a local calling area map can be retrieved from the database 120.

FIG. 2 shows a block diagram of a server 204 for generating maps in accordance with the technique described above. The server 204 includes a data validation and data processing module 212. The data validation and data processing module 212 receives as input data files 216 (e.g., File_{—}1, File_{—}2, and/or File_{—}3). The data validation and data processing module 212 processes and/or validates the received data (e.g., data files 216). In one embodiment, the data validation includes validating (e.g., checking the data's accuracy) and normalizing the data (e.g., converting the data to a standard format). The resulting data 220 is then input into a geo-processing module 224.

Further, rate center polygons 228 may be transmitted to a rule engine 232. The rule engine 232 processes the rate center polygons using one or more rules and transmits its output 236 to the geo-processing module 224. In one embodiment, the rule engine 232 uses the rate center polygons 228 to generate boundary lines for a map.

In one embodiment, the rule engine 232 enables customization of maps (or tables) using one or more rules. In one embodiment, the rules enable the adjustment or customization (e.g., changing of the color) of a map. An example of a rule is to color a specific area code and/or zip code on a map a particular color.

The geo-processing module 224 generates one or more maps (and/or one or more tables) from the resulting data 220 and the output 236 and stores the map(s) (and/or tables) in a maps and tables database 208. In one embodiment, the geo-processing module 224 determines the exact coordinates of a local calling area in terms of, for instance, latitude and longitude.

When a query is received, the server 204 may retrieve information from the maps and tables database 208 to answer the query. The server 204 may also locate and retrieve a map corresponding to the query and provide the map to the party after receipt of a query.

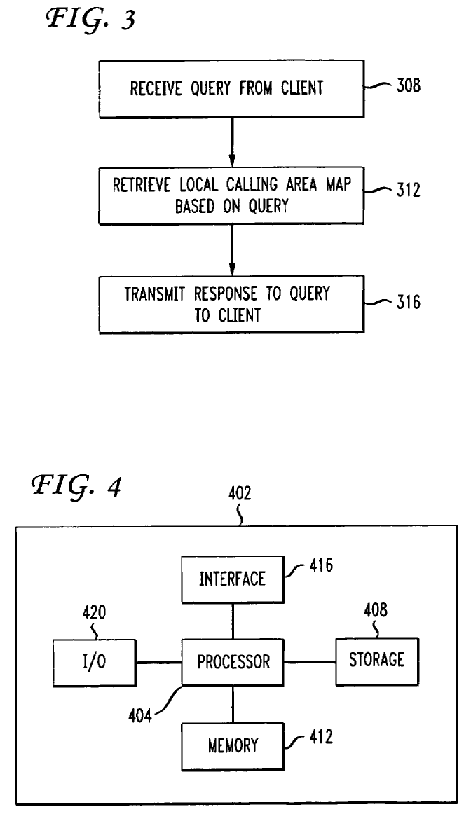

FIG. 3 shows a flowchart illustrating the steps performed by the server to transmit a local calling area map to a calling party. The server once (before a query is received), a predetermined number of times, or periodically generates and indexes a plurality of local calling area maps.

The server receives a query from the client in step 308. The query can include a portion (e.g., the first six digits) of the calling party's telephone number or the entire calling party's telephone number. The server then retrieves a local calling area map from the plurality of local calling area maps based on the query in step 312.

The server transmits a response to the query back to the client in step 316. In one embodiment, the server determines, based on the query, whether to transmit to the client the retrieved local calling area map or a table as the response. Further, the server may determine to transmit an answer to the query indicating whether a specific call is a local call as the response to the query. For example, if the query contains the calling telephone number (or a portion of the calling telephone number) only, then the server may provide the client with the retrieved local calling area map or table (e.g., indicating area codes that are local calls) for the calling telephone number.

The previous and following description describes the present invention in terms of the processing steps required to implement an embodiment of the invention. These steps may be performed by an appropriately programmed computer, the configuration of which is well known in the art. An appropriate computer may be implemented, for example, using well known computer processors, memory units, storage devices, computer software, and other components. A high level block diagram of such a computer is shown in FIG. 4. Computer 402 contains a processor 404 which controls the overall operation of computer 402 by executing computer program instructions which define such operation. The computer program instructions may be stored in a storage device 408 (e.g., magnetic disk) and loaded into memory 412 when execution of the computer program instructions is desired. Computer 402 also includes one or more interfaces 416 for communicating with other devices (e.g., locally or via a network). Computer 402 also includes input/output 420 which represents devices which allow for user interaction with the computer 402 (e.g., display, keyboard, mouse, speakers, buttons, etc.). The computer 402 can represent, for example, the server.

One skilled in the art will recognize that an implementation of an actual computer will contain other components as well, and that FIG. 4 is a high level representation of some of the components of such a computer for illustrative purposes. In addition, one skilled in the art will recognize that the processing steps described herein may also be implemented using dedicated hardware, the circuitry of which is configured specifically for implementing such processing steps. Alternatively, the processing steps may be implemented using various combinations of hardware and software. Also, the processing steps may take place in a computer or may be part of a larger machine.

The foregoing Detailed Description is to be understood as being in every respect illustrative and exemplary, but not restrictive, and the scope of the invention disclosed herein is not to be determined from the Detailed Description, but rather from the claims as interpreted according to the full breadth permitted by the patent laws. It is to be understood that the embodiments shown and described herein are only illustrative of the principles of the present invention and that various modifications may be implemented by those skilled in the art without departing from the scope and spirit of the invention. Those skilled in the art could implement various other feature combinations without departing from the scope and spirit of the invention.

1. A method for providing a calling area map to a client device comprising:
receiving a query from said client device, said query comprising at least a portion of a calling telephone number;
retrieving a calling area map associated with said at least a portion of a calling telephone number from a plurality of stored calling area maps; and
transmitting said retrieved calling area map to said client device.

2. The method of claim 1 further comprising generating said plurality of stored calling area maps.

3. The method of claim 1 wherein said calling area is a local calling area.

4. The method of claim 1 wherein said query further comprises at least a portion of a called telephone number.

5. The method of claim 4 wherein said transmitting of said retrieved calling area map further comprises transmitting a table associated with said calling area.

6. The method of claim 2 wherein said generating step further comprises determining boundary lines for each of said plurality of stored calling area maps.

7. A system for providing, to a client device, a calling area map comprising:
a database storing a plurality of calling area maps associated with different calling telephone numbers; and
a server configured to retrieve a calling area map associated with said at least a portion of a calling telephone number in response to a query comprising at least said portion of said calling telephone number.

8. The system of claim 7 wherein said calling area map further comprises a table associated with said calling area.

9. The system of claim 7 wherein said server is further configured to generate said stored plurality of calling area maps.

10. The system of claim 7 wherein said calling area is a local calling area.

11. The system of claim 7 wherein said query further comprises at least a portion of a called telephone number.

12. The system of claim 7 wherein said server is further configured to transmit said retrieved calling area map to said client device.

13. The system of claim 9 wherein said server is further configured to determine boundary lines for each of said plurality of calling area maps.

14. A system for providing a calling area map to a client device comprising:
means for receiving a query from said client device, said query comprising at least a portion of a calling telephone number;
means for retrieving a calling area map associated with said at least a portion of a calling telephone number from a plurality of stored calling area maps; and
means for transmitting said retrieved calling area map to said client device.

15. The system of claim 14 further comprising means for generating said plurality of stored calling area maps.

16. The system of claim 14 wherein said calling area is a local calling area.

17. The system of claim 14 wherein said query further comprises at least a portion of a called telephone number.

18. The system of claim 17 wherein said means for transmitting said retrieved calling area map to said client device further comprises means for transmitting a table associated with said calling area.

19. The system of claim 15 wherein said means for generating further comprises means for determining boundary lines for each of said plurality of stored calling area maps.

20. A method for providing information about a calling area to a client device comprising:
receiving a query from said client device, said query comprising at least a portion of a calling telephone number;
retrieving information about said calling area corresponding to said at least a portion of said calling telephone number from at least one file; and
transmitting at least one of a map and a table based on said retrieved information and associated with said calling area to said client device.
